(19) United States
(12) Patent Application Publication
(10) Pub. No.: US 2009/0009599 A1
(43) Pub. Date: Jan. 8, 2009

(54) Intelligent surveillance system and method of controlling the same

(75) Inventor: Hyung-suk Lee, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/075,410

(22) Filed: Mar. 11, 2008

(30) Foreign Application Priority Data
Jul. 3, 2007 (KR) 10-2007-0066776

(51) Int. Cl. H04N 7/18; G06K 9/00

(52) U.S. Cl. 348/143; 382/103; 348/E07.085

(57) ABSTRACT

An intelligent surveillance system and a method of controlling the same. The intelligent surveillance system and method monitor a specific surveillance region. When detecting a specific object in the surveillance region during surveillance, the intelligent surveillance system and method determine the risk of the detected object and automatically changes a tracking object based on the determined result. The intelligent surveillance system includes a surveillance unit installed in a specific region for monitoring at least a portion of the specific region as a surveillance region and detecting a plurality of moving objects in the surveillance region, a control unit for determining the risk of each of the moving objects detected by the surveillance unit and selecting at least one of the moving objects as tracking objects on the basis of the risk, and a tracking unit for tracking the tracking object.

### CROSS-REFERENCE TO RELATED PATENT APPLICATION

This application claims the benefit of Korean Patent Application No. 10-2007-0066776, filed on Jul. 3, 2007, in the Korean Intellectual Property Office, the disclosure of which is incorporated herein in its entirety by reference.

### BACKGROUND OF THE INVENTION

1. Field of the Invention

The present invention relates to an intelligent surveillance system and a method of controlling the same, and more particularly, to an intelligent surveillance system which is installed in a specific region to conduct surveillance of the specific region and tracks a specific object when the specific object is detected, and a method of controlling the same.

2. Description of the Related Art

A surveillance system recognizes an object by processing an image received from a camera installed in a specific place or a mobile camera and monitors a specific region. Surveillance systems may be applied to any security system using images, such as intelligent surveillance and monitoring robots, General OutPost (GOP) scientific systems, social security robot systems, etc.

A surveillance system may be installed in a specific surveillance region to monitor the specific surveillance region. Thus, when detecting a specific object in the surveillance region, the surveillance system may track the specific object. When detecting a plurality of moving objects in the surveillance region, the surveillance system can attempt to track a first moving object that enters the surveillance region before anything else.

Therefore, even if other moving objects are detected, the surveillance system keeps tracking the first moving object as long as a user does not provide any special command. Thus, when an intruder inserts a moving object, such as a wireless control car, into the surveillance region before entering the surveillance region, the surveillance system only tracks the wireless control car. As a result, even if a person or other moving object with higher risk is detected, the surveillance system cannot take any measures to track that person or object.

### SUMMARY OF THE INVENTION

The present invention provides an intelligent surveillance system, which monitors a specific surveillance region, and a method of controlling the same. When detecting a specific object in the surveillance region during surveillance, the intelligent surveillance system determines the risk of the detected object and may automatically change a tracking object based on the determined result.

An intelligent surveillance system according to an embodiment of the present invention includes a surveillance unit installed in a specific region for monitoring at least a portion of the specific region as a surveillance region and detecting a plurality of moving objects in the surveillance region, a control unit for determining the risk of each of the moving objects detected by the surveillance unit and selecting at least one of the moving objects as tracking objects on the basis of the risk, and a tracking unit for tracking the tracking object. The control unit may select at least one moving object having the highest risk out of the moving objects detected in the surveillance region as the tracking object. The risk may be determined by the sum of the products of at least two risk variables and weight values for the respective risk variables.

The surveillance unit may include an image input element for receiving an image from the surveillance region, and an image analysis element for analyzing the image received from the image input element to detect the moving object. The tracking unit may include an image input element for receiving an image of the tracking object, and an image analysis element for analyzing the image received from the image input element to allow the image input portion to track the tracking object. The image input element may include a camera for receiving the image, and a driving gear combined with the camera to move or rotate the camera. The surveillance unit may further include one of a radar sensor, an acoustic sensor, and a vibration sensor to sense the motion of an object in the surveillance region.

In addition, a method for controlling an intelligent surveillance system according to an embodiment of the present invention includes monitoring at least a portion of a specific region as a surveillance region, detecting a plurality of moving objects in the surveillance region, determining the risk of each of the detected moving objects, selecting at least one of the moving objects as tracking objects on the basis of the risk, and tracking the tracking object. The intelligent surveillance system on which the method can be performed can include all of the features discussed above with regard to, for example, the control unit, surveillance unit, tracking unit, image input element, and so on.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an example of an intelligent surveillance system according to an embodiment of the present invention;

FIG. 2 is a block diagram of an example of an intelligent surveillance system in which a surveillance unit and a tracking unit are integrally formed, according to another embodiment of the present invention;

FIG. 3 is a block diagram of an example of an intelligent surveillance system including a fixed surveillance unit, according to another embodiment of the present invention;

FIG. 4 is a diagram for explaining an example of preset-type surveillance of the surveillance unit of the intelligent surveillance systems illustrated in FIGS. 1 and 2, according to an embodiment of the present invention;

FIG. 5 is a diagram for explaining an example of scan-type surveillance of the surveillance unit of the intelligent surveillance system illustrated in FIGS. 1 and 2, according to an embodiment of the present invention; and

FIG. 6 is a flowchart illustrating an example of operations of a method for controlling an intelligent surveillance system according to an embodiment of the present invention.

### DETAILED DESCRIPTION OF THE EMBODIMENTS

An intelligent surveillance system and a method of controlling the same according to embodiments of the present invention will now be described more fully hereinafter with reference to the accompanying drawings.

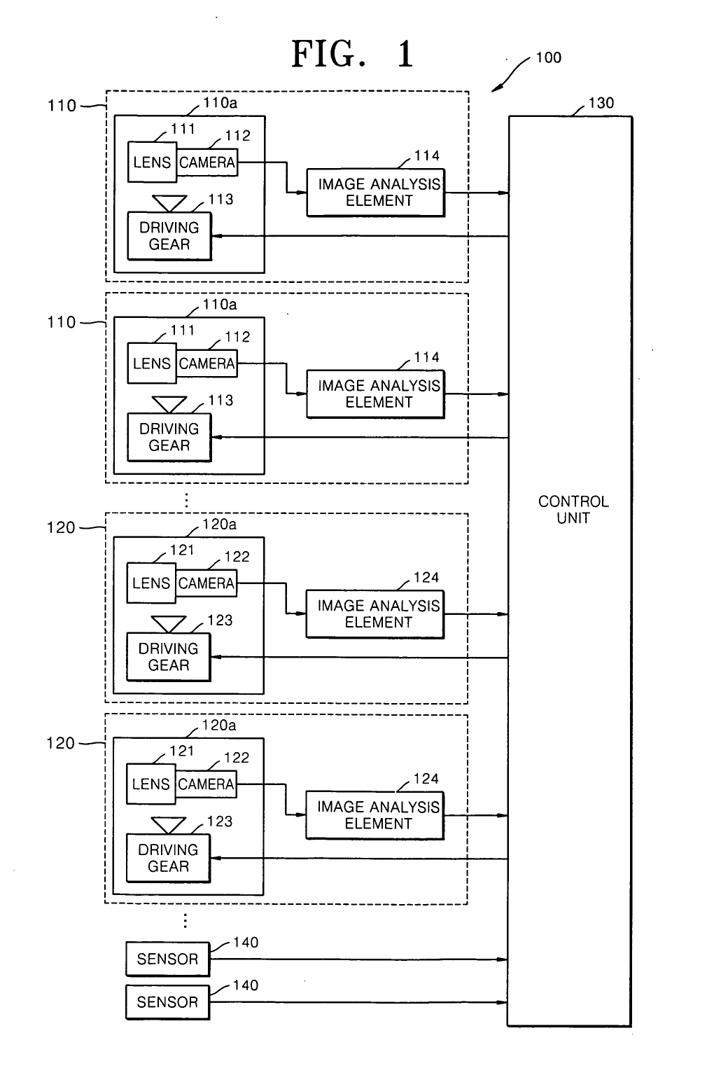

FIG. 1 is a block diagram of an example of an intelligent surveillance system 100 according to an embodiment of the present invention. The intelligent surveillance system 100 monitors a specific surveillance region. When detecting a specific object in the surveillance region during surveillance, the intelligent surveillance system 100 determines the risk of the detected object and may automatically change a tracking object based on the determined result.

Therefore, while the intelligent surveillance system 100 sequentially performs surveillance, detection, and tracking operations, the number of unnecessary tracking operations can be minimized. Also, blind spots that may occur during a tracking operation can be minimized. Furthermore, the risk of a moving object to be tracked can be determined in real-time or substantially real-time, so that a tracking object can be updated based on the determined result. As a result, the intelligent surveillance system 100 can adjust to environmental changes.

Referring to FIG. 1, the intelligent surveillance system 100 in this example includes at least one surveillance unit 110, at least one tracking unit 120, and a control unit 130. In this example, two surveillance units 110 and two tracking units 120 are shown. The surveillance unit 110 monitors a surveillance region in a preset or panoramic mode. When detecting a moving object during surveillance, the surveillance unit 110 transmits the coordinates of the moving object to the control unit 130, and the tracking unit 120 tracks the moving object using the coordinates of the moving object, which are received from the control unit 130.

That is, the surveillance unit 110, which is installed in a specific region, monitors at least a portion of the specific region as a surveillance region and may detect a moving object in the surveillance region. The control unit 130 determines the risk of the moving object detected by the surveillance unit 110 and selects an object to be tracked by the tracking unit 120 on the basis of the risk. The tracking unit 120 tracks the object selected by the control unit 130.

In this case, the surveillance unit 110 recognizes the position of the moving object and generates positional information on the moving object. The tracking unit 120 may receive positional information on the tracked object through the control unit 130 and track the object based on the positional information.

Each surveillance unit 110 according to this embodiment may include an image input element 110a and an image analysis element 114 so that the surveillance unit 110 can detect a moving object in the surveillance region. The image input element 110a receives an image from the surveillance region. The image analysis portion 114 analyzes the image received from the surveillance region and detects a moving object.

In other words, the surveillance unit 110 in the example illustrated in FIG. 1 can be referred to as an image system, which analyzes images received from the image input element 110a using the image analysis element 114 to detect a moving object. In this case, the surveillance unit 110 may include a single image system or a plurality of image systems. Also, the surveillance unit 110 according to this embodiment of the present invention is not limited to the foregoing image system, and various kinds of sensors 140 may be used instead of or along with at least one image system to constitute the surveillance unit 110.

Each of the sensors 140 may be at least one of a radar sensor, an acoustic sensor, and a vibration sensor, which can sense the motion of an object in the surveillance region. The sensors 140 may be various different sensors and are not restricted to a radar sensor, an acoustic sensor, and a vibration sensor.

The surveillance unit 110 detects a moving object using the sensors 140 and transmits the coordinates of the moving object to the control unit 130. Thus, when the moving object starts to be tracked, the control unit 130 transmits the coordinates of the moving object to the tracking unit 120 so that the tracking unit 120 can track the moving object using the coordinates.

In the intelligent surveillance system 100 illustrated in FIG. 1, the sensors 140 are used along with the surveillance unit 110 including image systems. In the current embodiment of the present invention, a moving object may be detected by the surveillance unit 110 including at least one of the image systems and the sensors 140.

The image input element 110a, which receives an image, may include a lens 111, a camera 112, and a driving gear 113. The camera 112 receives the image. The driving gear 113 is combined with the camera 112 and moves or rotates the camera 112.

The lens 111 may be zoomed in and out. Thus, the lens 111 enables the camera 112 to receive a more detailed image of a narrow region or an image of a wide region.

The camera 112 may be combined with the lens 111 and receive an image through the lens 111. The driving gear 113 can move the lens 111 or the camera 112 in response to a command received from the control unit 130. In this case, the driving gear 113 may include a pan/tilting system to change the pan/tilting angles of a surveillance region from which images are received by the camera 112.

In another embodiment of the present invention, the image input element 110a may be a mobile patrol robot that follows a predetermined path. In this case, the driving gear 113 may not only change the pan/tilting angles of a surveillance region but also move the camera 112 to another position.

Also, as discussed above, the surveillance unit 110 may monitor the surveillance region in a preset or panoramic mode. Specifically, the surveillance unit 110 may monitor the surveillance region by moving or rotating the camera 112 in a preset order. Alternatively, according to the panoramic mode, a specific region is divided into a plurality of surveillance regions so that the surveillance unit 110 can sequentially monitor the surveillance regions by moving or rotating the camera 112 in one direction.

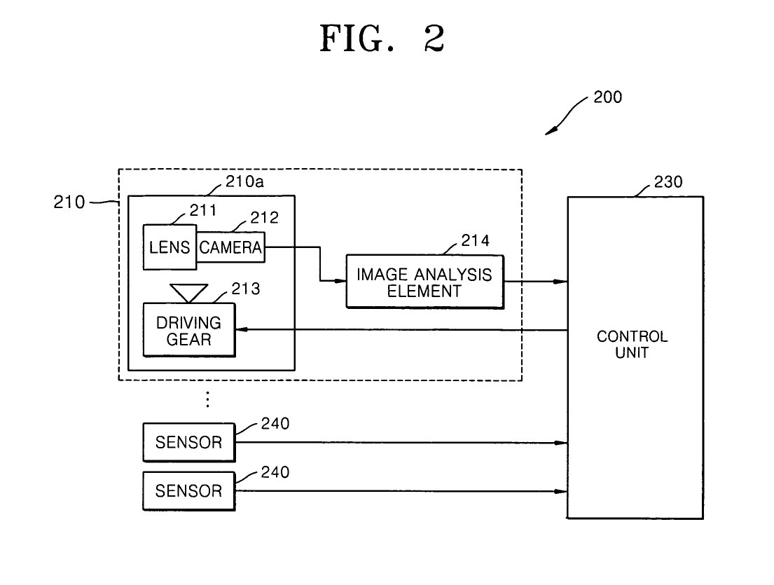

FIG. 2 is a block diagram of an example of an intelligent surveillance system 200 in which a surveillance unit and a tracking unit are integrally formed, according to another embodiment of the present invention. The intelligent surveillance system 200 according to this embodiment of the present invention is generally similar to the intelligent surveillance system 100 illustrated in FIG. 1 except that the surveillance unit and the tracking unit of the intelligent surveillance system 200 are integrally formed. Thus, the intelligent surveillance system 200 includes a surveillance and tracking unit 210. Similar reference numerals are used to denote the same elements as in FIG. 1, and thus a further description of them need not be provided. Referring to FIG. 2, the intelligent surveillance system 200 in this example includes the surveillance and tracking unit 210, a controller 230, and a plurality of sensors 240.

The surveillance and tracking unit 210 in this example includes an image input element 210a and an image analysis element 214. The surveillance and tracking unit 210 monitors a surveillance region using the image input element 210a in a preset or panoramic mode in a surveillance mode. Thus, when the surveillance and tracking unit 210 detects a moving object during surveillance, the controller 230 selects a tracking object. In this case, the surveillance and tracking unit 210 is switched to a tracking mode and starts to track the selected object. Also, the surveillance and tracking unit 210 may be switched to the surveillance mode in response to a surveillance mode conversion command provided from the control unit 230 and monitors the surveillance region.

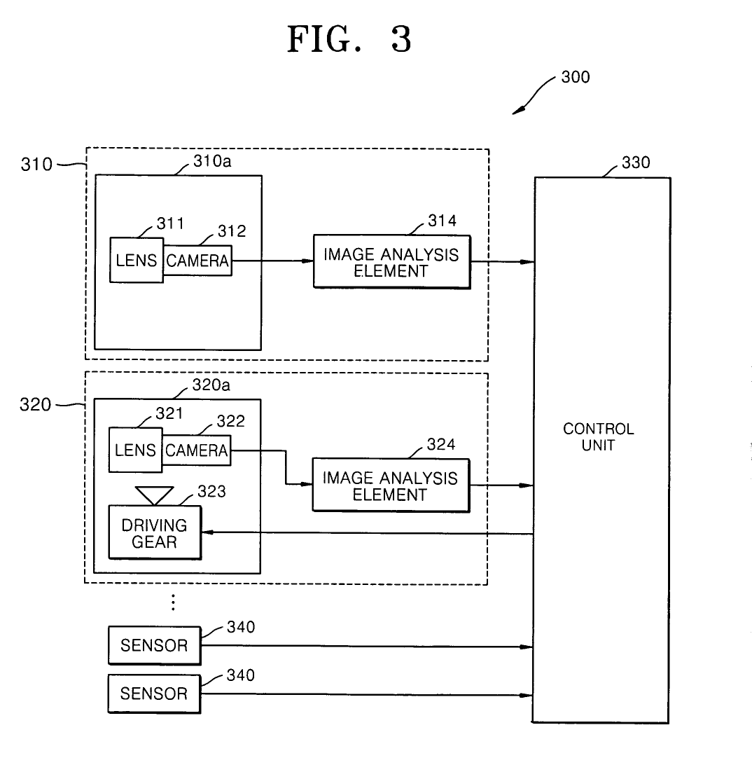

FIG. 3 is a block diagram of an example of an intelligent surveillance system 300 including a fixed surveillance unit 310, according to another embodiment of the present invention. The intelligent surveillance system 300 according to this embodiment of the present invention is generally similar to the intelligent surveillance system 100 illustrated in FIG. 1, except for the fixed surveillance unit 310. Similar reference numerals are used to denote the same elements as in FIG. 1, and thus a further description of them need not be provided. Referring to FIG. 3, the intelligent surveillance system 300 according to the current embodiment of the present invention includes the fixed surveillance unit 310, a tracking unit 320, a control unit 330, and a plurality of sensors 340.

In the intelligent surveillance system 300 according to this embodiment of the present invention, the fixed surveillance unit 310 includes an image input element 310a and an image analysis element 314. The image input element 310a may include a lens 311 and a fixed camera 312, but a driving gear may not be included.

In this case, the fixed surveillance unit 310 monitors a surveillance region using the fixed camera 312 of the image input element 310a. When the fixed surveillance unit 310 detects a moving object during surveillance, the control unit 330 determines the risk of the moving object detected by the surveillance unit 310 and selects an object to be tracked by the tracking unit 320 on the basis of the risk. The tracking unit 320 receives the coordinates of the selected object from the surveillance unit 310 through the control unit 330 and tracks the selected object.

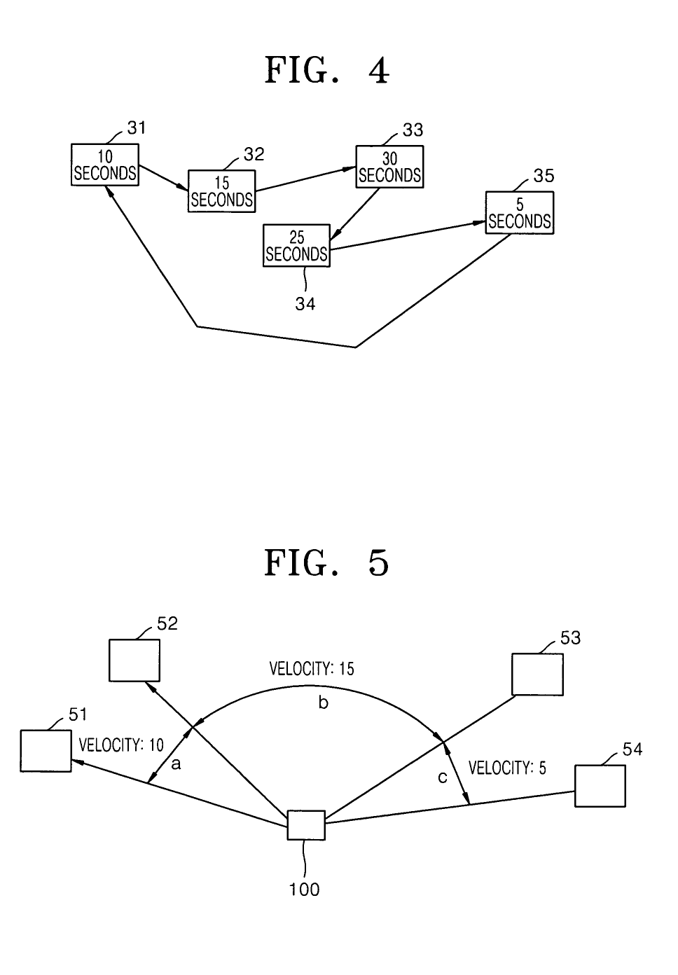

FIG. 4 is a diagram for explaining an example of a preset-type surveillance operation of the surveillance units 110 and 210 of the intelligent surveillance systems 100 and 200 illustrated in FIGS. 1 and 2, respectively, according to an embodiment of the present invention. Hereinafter, the preset-type surveillance operation will be exemplarily described with reference to FIGS. 1 and 4. However, it is clear that the preset-type surveillance operation can be applied likewise to the intelligent surveillance system 200 illustrated in FIG. 2.

In a preset method, target regions may be set to presets 31 to 35, respectively, and the surveillance order and pause time of each of the presets 31 to 35 may be determined. The target regions may be divided into first through fifth presets 31 to 35, and a pause time may be 10, 15, 30, 25, and 5 seconds in the first through fifth presets 31 to 35, respectively. In this case, a preset of higher priority may have a longer pause time. Thus, the third preset 33, the fourth preset 32, the second preset 32, the first preset 31, and the fifth preset 35 may be prioritized in this order.

FIG. 5 is a diagram for explaining an example of a scan-type surveillance operation of the surveillance units 110 and 210 of the intelligent surveillance systems 100 and 200 illustrated in FIGS. 1 and 2, respectively, according to an embodiment of the present invention. Hereinafter, the scan-type surveillance operation will be exemplarily described with reference to FIGS. 1 and 5. However, it is clear that the scan-type surveillance operation can be applied likewise to the intelligent surveillance system 200 shown in FIG. 2.

In a scan-type method, target regions may be divided into a first scan period “a” between reference locations 51 and 52, a second scan period “b” between reference locations 52 and 53, and a third scan period “c” between reference locations 53 and 54, and moving velocities of 10, 15, and 5 deg/sec may be set in the first through third scan periods “a”, “b”, and “c”, respectively. In this case, a camera moves more slowly in a scan period of higher priority to receive images. Thus, the third scan period “c”, the second scan period “b”, and the first scan period “a” may be prioritized in this order.

In a panoramic method, target regions are set to scan periods “a”, “b”, and “c”, respectively, and a moving velocity may be determined in each of the scan periods “a”, “b”, and “c”. Thus, a moving velocity or moving time is reset according to priority, so that a method of receiving images from the target regions can be changed.

Referring to FIG. 1, the control unit 130 determines the risk of a moving object detected by the surveillance unit 110 and selects an object to be tracked by the tracking unit 120 on the basis of the risk. The control unit 130 may correspond to a central processing unit (CPU) of a computer. The control unit 130 selects at least one moving object as a tracking object out of moving objects detected in the surveillance region. To select the tracking object, the control unit 130 can analyze data received from the image analysis element 114 of the surveillance unit 110, determine the risk of the moving object using various algorithms, and operate the entire intelligent surveillance system 100.

Although a single tracking object may be selected, when at least two tracking units 120 are provided as illustrated in FIG. 1, at least two tracking objects may be selected. In this case, moving objects having higher risks may be selected as the tracking objects, such that the number of moving objects is equal to the number of the tracking units 120. That is, the risks of the respective moving objects may be calculated, the moving objects may be prioritized on the basis of the risk, and the tracking objects may be determined according to priority.

The risk may be determined by the sum of the products of at least two risk variables and weight values for the respective risk variables. In this case, the risk variables may include at least one of shape, size, moving velocity, and accessibility of the moving object. However, the risk variables according to the present invention are not restricted to the above description and may include other different variables.

That is, the priorities of the respective moving objects are readjusted according to the risk. In this case, the risk may be determined by the sum of the products of risk variables and weight values for the respective risk variables. Specifically, a reference value of each moving object is calculated as shown in Equation 1, and the priority of the corresponding moving object may be determined based on the reference value as follows

Reference value=Ax+By+Cz+ (Equation 1),

where A, B, C denote risk variables, and x, y, and z denote weight values for the respective risk variables A, B, and C.

Also, the control unit 130 controls the drive of an image input element 120a of the tracking unit 120 according to the priority that is determined based on the reference value calculated using Equation 1. In this case, the image input element 120a of the tracking unit 120 can track a tracking object using a tracking algorithm for tracking moving objects.

The tracking unit 120 tracks a tracking object selected by the control unit 130. The tracking unit 120 may receive information on the position of a tracking object that is recognized by the surveillance unit 110, so that the tracking unit 120 can track the tracking object based on the information.

The tracking unit 120 may include the image input element 120a and an image analysis element 124 so as to recognize the tracking object. The tracking unit 120 may have the same or approximately the same configuration as the surveillance unit 110.

The image input element 120a receives an image of the tracking object. The image analysis portion 124 receives the image from the image input element 120a, analyzes the received image, and recognizes the coordinates of the tracking object. A single tracking unit 120 or a plurality of tracking units 120 may be provided. Also, the tracking unit 120 may track a plurality of tracking objects.

The image input element 120a, which receives the image of the tracking object, may include a lens 121, a camera 122, and a driving gear 123. The camera 122 receives the image of the tracking object. The driving gear 123 is combined with the camera 122 and moves or rotates the camera 122.

The lens 121 may be zoomed in and out. Thus, the lens 121 enables the camera 122 to receive a more detailed image of a narrow region or an image of a wide region.

The camera 122 may be combined with the lens 121 and receive an image through the lens 121. The driving gear 123 can move the lens 121 or the camera 122 in response to a command received from the control unit 130.

In this case, the driving gear 123 may include a pan/tilting system to change pan/tilting angles according to the position of the tracking object. The image input element 120a of the tracking unit 120 can track the tracking object using a tracking algorithm for tracking moving objects.

As can be appreciated from the above, the intelligent surveillance system 100 according to the embodiments of the present invention can minimize the number of unnecessary tracking operations during sequentially performed operations including surveillance, detection, and tracking operations. Also, blind spots that can be generated during the tracking operation can be reduced. Moreover, the risk of a moving object to be tracked can be determined in real-time, so that a tracking object can be updated based on the determined result. Therefore, the intelligent surveillance system 100 can adjust to environmental changes.

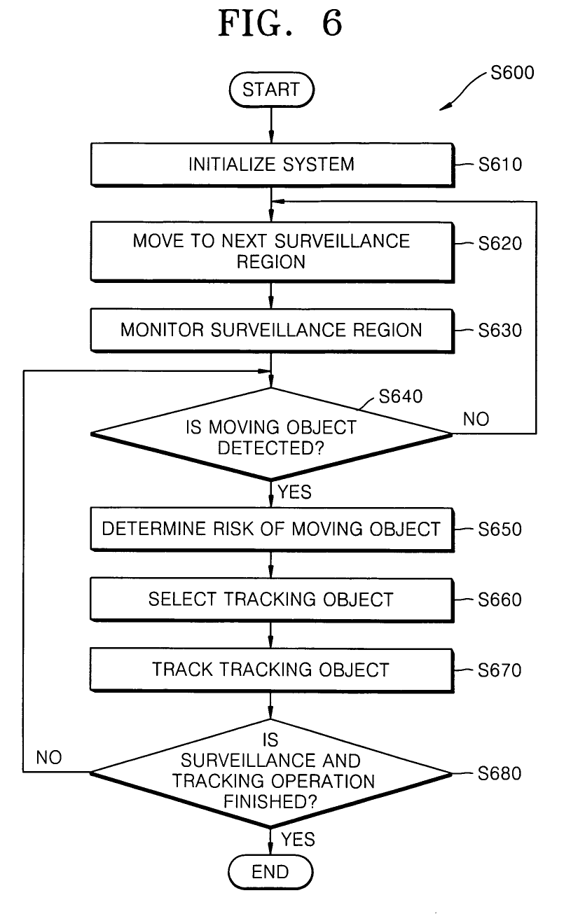

FIG. 6 is a flowchart illustrating an example of a method S600 of controlling an intelligent surveillance system, according to an embodiment of the present invention.

The method S600 of controlling an intelligent surveillance system according to this embodiment includes monitoring a specific surveillance region. Thus, when a specific object is detected in the surveillance region during surveillance, the risk of the detected object is determined so that the intelligent surveillance system can automatically change a tracking object.

Thus, while the intelligent surveillance system sequentially performs surveillance, detection, and tracking operations, the number of unnecessary tracking operations can be minimized. Also, blind spots that may occur during a tracking operation can be minimized. Furthermore, the risk of a moving object to be tracked can be determined in real-time so that a tracking object can be updated based on the determined result. As a result, the intelligent surveillance system can adjust to environmental changes. The method S600 may be applied to the intelligent surveillance systems 100, 200, and 300 illustrated in FIGS. 1 through 3, respectively, and embodied using the surveillance units 110, 210, and 310, the tracking units 120, 220, and 320, and the control units 130, 230, and 330.

Referring to FIG. 6, the method S600 may include an initialization operation S610, surveillance operations S620 and S630, a detection operation S640, a risk decision operation S650, a tracking object selection operation S660, and a tracking object tracking operation S670, which are discussed in more detail below

In the surveillance operation S620 and S630, at least a portion of a specific region is monitored as a surveillance region. In the detection operation S640, a moving object is detected in the surveillance region. In the risk decision operation S650, the risk of the detected moving object is determined.

In the tracking object selection operation S660, a moving object having the highest risk is selected out of detected moving objects as a tracking object. In the tracking object tracking operation S670, the tracking object is tracked.

According to the method S600, the intelligent surveillance system is initialized in operation S610 so that risk variables and weight values for the respective risk variables are set. Also, preset operations required for the surveillance operation S620 and S630 are performed.

When the surveillance operation S620 and S630 is performed in a preset mode, respective presets are determined in advance, and every surveillance preset is interlocked with a tracking unit, so that the tracking unit can track a tracking object using the coordinates of a dangerous object detected by a surveillance unit. In addition, image conversion coordinates are set such that the surveillance unit and the tracking unit can monitor and track an object using received images.

In the surveillance operation S620 and S630, as described above, at least the portion of the specific region is monitored as the surveillance region. In this case, the surveillance operation S620 and S630 may be performed using the surveillance unit, which may be a fixed surveillance unit, a mobile surveillance unit, or a combination thereof.

When a mobile surveillance unit is used, operation S620 of moving a camera to the surveillance region is needed. However, when a fixed surveillance unit is used, operation S620 may be omitted. In the surveillance operation S620 and S630, a specific region is divided into a plurality of surveillance regions so that the surveillance unit can sequentially monitor the surveillance regions in a predetermined order or at random using a camera.

In this embodiment, while watching over the respective surveillance regions, the surveillance unit detects a moving object in operation S640 and selects a tracking object in operation S660. Thus, when the moving object is detected in each of the surveillance regions, a tracking object is updated considering the risk of the moving object, and then the next surveillance region is monitored before surveillance and tracking operations are completed in operation S680.

When the mobile surveillance unit is used, the surveillance region may be monitored using a preset method, a panoramic method, or a combination thereof. In one example, the surveillance region is monitored by moving or rotating the camera in a preset order as illustrated in FIG. 4. In the panoramic method, a specific region is divided into a plurality of surveillance regions, so that the surveillance regions are sequentially monitored by moving or rotating the camera in one direction, as illustrated in FIG. 5.

In the detection operation S640, a moving object is detected in the surveillance region. However, when no moving object is detected, the surveillance unit moves to the next surveillance region in operation S620. When the moving object is detected, the risk decision operation S650 is performed.

In the risk decision operation S650, the risk of the detected moving object is determined. The risk may be determined by the sum of the products of at least two risk variables and weight values for the respective risk variables.

In this case, the risk variables may include at least one of shape, size, moving velocity, and accessibility of the moving object. However, the risk variables according to the present invention are not restricted to the above description and may include other various variables. The risk may be determined using Equation 1.

In the tracking object selection operation S660, a tracking object is selected out of the moving objects on the basis of the risk. In this case, at least one moving object having the highest risk may be selected as the tracking object out of the moving objects detected in the surveillance region.

In this case, a single tracking object or at least two tracking objects may be selected. When at least two tracking objects are selected, a tracking object having a higher risk can be tracked earlier than a tracking object having a lower risk. Specifically, the risks of the respective moving objects are calculated, and the moving objects are prioritized based on the risk, so that the tracking objects can be determined in the order of priority.

In other words, the order of priority of the moving objects may be updated on the basis of the risk. Reference values of the respective moving objects are calculated using Equation 1 set forth above, or in any other suitable manner, and the order of priority can be decided considering the reference values. Therefore, when a moving object having a higher risk is detected during the tracking of a tracking object, the moving object having the higher risk may be tracked as a new tracking object.

Furthermore, in the surveillance operation S630, the position of the moving object may be recognized to generate positional information. In the tracking object tracking operation S670, an object corresponding to the positional information may be tracked as a tracking object.

As a consequence, the method of controlling an intelligent surveillance system according to an embodiment the present invention can minimize the number of unnecessary tracking operations while the surveillance unit sequentially performs surveillance, detection, and tracking operations. Also, blind spots that may be generated during the tracking operation can be minimized. In addition, the risk of a moving object to be tracked can be determined in real-time so that a tracking object can be updated based on the determined result. Therefore, the intelligent surveillance system according to the present invention can adjust to environmental changes. Hence, as can be appreciated from the above, when the system and method according to the embodiments of the present invention detect a specific object in a surveillance region, the risk of the detected object is determined and a tracking object may be automatically changed based on the determined result, so that a dangerous object can be monitored and tracked more efficiently.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An intelligent surveillance system comprising:
at least one surveillance unit installed in a specific region for monitoring at least a portion of the specific region as a surveillance region and detecting a plurality of moving objects in the surveillance region;
a control unit for determining the risk of each of the moving objects detected by the surveillance unit and selecting at least one of the moving objects as tracking objects on the basis of the risk; and
at least one tracking unit for tracking the tracking object.

2. The system of claim 1, wherein the surveillance unit and the tracking unit are integrally formed together.

3. The system of claim 1, wherein the surveillance unit is fixed.

4. The system of claim 1, comprising a plurality of said surveillance units and a plurality of tracking units.

5. The system of claim 1, wherein the control unit selects at least one moving object having the highest risk out of the moving objects detected in the surveillance region as the tracking object.

6. The system of claim 1, wherein the risk is determined by the sum of the products of at least two risk variables and weight values for the respective risk variables.

7. The system of claim 6, wherein the risk variables comprise at least one of shape, size, moving velocity, and accessibility of the moving object.

8. The system of claim 1, wherein the surveillance unit comprises:
an image input element for receiving an image from the surveillance region; and
an image analysis element for analyzing the image received from the image input element to detect the moving object.

9. The system of claim 1, wherein the tracking unit comprises:
an image input element for receiving an image of the tracking object; and
an image analysis element for analyzing the image received from the image input element to allow the image input element to track the tracking object.

10. The system of claim 8, wherein the image input element comprises:
a camera for receiving the image; and
a driving gear combined with the camera to move or rotate the camera.

11. The system of claim 1, wherein the surveillance unit comprises at least one of a radar sensor, an acoustic sensor, and a vibration sensor to sense the motion of an object in the surveillance region.

12. The system of claim 1, wherein the surveillance unit monitors the surveillance region using one of a preset method and a panoramic method, the preset method being a method whereby the surveillance unit moves or rotates in a preset order to monitor the surveillance region, the panoramic method being a method whereby the specific region is divided into a plurality of surveillance regions and the surveillance unit moves or rotates in one direction to sequentially monitor the surveillance regions.

13. The system of claim 1, wherein
the surveillance unit recognizes the position of the moving object and generates positional information on the moving object, and
the tracking unit receives positional information on the tracking object through the control unit and tracks the tracking object based on the positional information on the tracking object.

14. A method of controlling an intelligent surveillance system, comprising:
monitoring at least a portion of a specific region as a surveillance region;
detecting a plurality of moving objects in the surveillance region;
determining the risk of each of the detected moving objects;
selecting at least one of the moving objects as tracking objects on the basis of the risk; and
tracking the tracking object.

15. The method of claim 14, wherein the determining determines the risk based on a sum of the products of at least two risk variables and weight values for the respective risk variables.

16. The method of claim 15, wherein the risk variables comprise at least one of shape, size, moving velocity, and accessibility of the moving object.

17. The method of claim 14, wherein the selecting selects as the tracking object at least one moving object having the highest risk out of the moving objects detected in the surveillance region.

18. The method of claim 14, wherein, when a moving object having a higher risk is detected during the tracking of the tracking object, the selecting selects the moving object having the higher risk as a new tracking object and tracked.

19. The method of claim 14, wherein the detecting generates positional information representing a position of the moving object, and the tracking tracks an object corresponding to the positional information as the tracking object.

20. The method of claim 14, wherein the monitoring of the surveillance region is performed using one of a preset method and a panoramic method, the preset method being a method whereby the intelligent surveillance system moves or rotates in a preset order to monitor the surveillance region, the panoramic method being a method whereby the specific region is divided into a plurality of surveillance regions and the intelligent surveillance system moves or rotates in one direction to sequentially monitor the surveillance regions.
